(19) United States
(12) Patent Application Publication
(10) Pub. No.: US 2002/0064585 A1
(43) Pub. Date: May 30, 2002

(54) Method for use of antimicrobial agents to inhibit microbial growth on ready to eat meat and poultry products

(76) Inventors: Richard Christianson, Austin, MN (US); Donald Tebay, Brownsdale, MN (US)

Correspondence Address: Michael L. Mau, Mau & Krull, P. A., Suite E, 1250 Moore Lake Drive East, Fridley, MN, 55432, US

(21) Appl. No.: 09/769,949

(22) Filed: Jan. 25, 2001

Related U.S. Application Data
(60) Provisional application No. 60/177,807, filed on Jan. 25, 2000.
(60) Provisional application No. 60/185,318, filed on Feb. 28, 2000.

(51) Int. Cl. A23L 3/34

(52) U.S. Cl. 426/326; 426/310; 426/392

(57) ABSTRACT

The present invention is a method of applying antimicrobial agents for killing and inhibiting foodborne microbial contamination and for extension of shelf life of cooked, ready to eat poultry and meat products and then packaging the products with the aid of a vacuum. Using this method, the antimicrobial agents are very effective at low product weight based concentrations.

This application claims priority under 35 U.S.C. 119(e) from provisional patent application Ser. No. 60/177,807 entitled Method for Use of Quaternary Ammonium Compounds to Prevent Microbial Contamination of Ready to Eat Meat and Poultry Products filed on Jan. 25, 2000 and No. 60/185,318 entitled Method for Use of Quaternary Ammonium Compounds to Prevent Microbial Contamination of Ready to Eat Meat and Poultry Products filed on Feb. 28, 2000.

### BACKGROUND OF THE INVENTION

1. Field of the Invention

The present invention relates to the inhibition of foodborne microbial growth and the extension of product shelf life of ready to eat poultry and meat products.

2. Description of the Prior Art

Prevention of foodborne illnesses by microbial contamination and extension of shelf life are of major concern to the poultry and meat processing industry, regulatory agencies, and consumers. In efforts to provide products free of microbial contamination, poultry and meat processors have encountered major difficulties in removing and preventing attachment of microorganisms to the surfaces of poultry and meat intended as food products. Microorganisms that become strongly attached cannot be removed by rinsing the food products and are resistant to removal by many chemical or physical means.

One microorganism of major concern is Listeria monocytogenes. Listeria monocytogenes has been found in poultry, meat, vegetables and various milk products; and may cause sepsis, meningitis and disseminated abscesses. Listeria monocytogenes is a cold tolerant microorganism capable of growing under refrigeration and can also grow in packages with little or no oxygen. In the United States, an estimated 1,850 people become seriously ill with listeriosis each year, and of these, 425 die.

The use of quaternary ammonium compounds to remove and prevent microbial contamination of raw poultry and meat products is known. U.S. Pat. No. 5,366,983 by Lattin et al. and U.S. Pat. No. 5,855,940 by Compadre et al. disclose the use of quaternary ammonium compounds, in particular cetylpyridinium chloride (“CPC”), to remove and prevent contamination of poultry and meat products by a broad spectrum of microorganisms, including the genus Salmonella. These patents describe the treatment of raw poultry and meat products and apply CPC in aqueous solutions or with a formulation comprising CPC, glycerin and/or ethyl alcohol. The methods of contacting poultry and meat products with CPC in these patents are generally shorter that five minutes, and this is accomplished by spraying the poultry and meat products with CPC.

U.S. Pat. No. 5,855,940 describes the effect of CPC on bacteria including the genus Salmonella, Staphylococcus, Campylobacter, and Escherichia. This patent also describes the effect of CPC on Listeria, Archobacter, Aeromonas and Bacillus, but because these genus were only studied in a model broth system as opposed to a model meat system, the sensitivity of a bacteria to an antimicrobial agent in a broth system may not be the same as its sensitivity in a meat system.

### SUMMARY OF THE INVENTION

The present invention is a method of using antimicrobial agents for killing and inhibition of foodborne microbial growth and for extension of shelf life of cooked, ready to eat poultry and meat products. In the preferred embodiment, the method uses antimicrobial agents such as quaternary ammonium compounds, such as cetylpyridinium chloride (“CPC”), liquid smoke, and an antimicrobial herbal extract such as Flavonoid Mist™ manufactured by Arnhem, Incorporated for removing and for inhibiting growth of foodborne microbial contamination of cooked, ready to eat poultry and meat products. The method focuses on killing and inhibiting growth of Listeria monocytogenes on cooked, ready to eat products, but the method could also be used to remove and inhibit other microorganisms from contaminating a range of different food products by using various other antimicrobial agents.

Methods of application of the antimicrobial agent include adding liquid to the finished product packaging aided by a vacuum, spraying a mist on the product surface just prior to vacuum packaging, spraying an electrostatic film coating as a fluidized powder or a liquid prior to vacuum packaging, passing the product through a cabinet with a spray mist or fog prior to vacuum packaging, or coating the packaging material with a dry powder containing the antimicrobial agent prior to vacuum packaging. Using these methods, antimicrobial agents are very effective for removal and inhibition of foodborne microbial growth and for extension of shelf life of cooked, ready to eat poultry and meat products at low product weight based concentrations.

In a preferred embodiment method of killing and inhibiting microbial growth of ready to eat meat and poultry products having an outer surface, an antimicrobial agent is applied to the outer surface of the ready to eat meat and poultry products. The antimicrobial agent has a surface concentration of at least approximately 100 ppm and a product weight based concentration of approximately 100 ppm or less. The ready to eat meat and poultry products are placed in packaging, and the packaging is sealed under a vacuum so that the packaging contacts the ready to eat meat and poultry products and uniformly distributes the antimicrobial agent on the outer surface of the products.

In another preferred embodiment method of killing and inhibiting microbial growth of ready to eat meat and poultry products having an outer surface, an antimicrobial agent is applied to the outer surface of the ready to eat meat and poultry products. The antimicrobial agent has a surface concentration of at least approximately 100 ppm. The ready to eat meat and poultry products are placed in packaging, and the packaging is sealed under a vacuum so that the packaging contacts the ready to eat meat and poultry products and uniformly distributes the antimicrobial agent on the outer surface of the products.

In another preferred embodiment method of killing and inhibiting microbial growth of ready to eat meat and poultry products having an outer surface, an antimicrobial agent is applied to the outer surface of the ready to eat meat and poultry products. The antimicrobial agent has a product weight based concentration of approximately 100 ppm or less. The ready to eat meat and poultry products are placed in packaging, and the packaging is sealed under a vacuum so that the packaging contacts the ready to eat meat and poultry products and uniformly distributes the antimicrobial agent on the outer surface of the products.

In another preferred embodiment method of killing and inhibiting microbial growth of food products having an outer surface, an antimicrobial agent is applied to the outer surface of the food products. The food products are placed in packaging, and the packaging is sealed under a vacuum so that the packaging contacts the food products and uniformly distributes the antimicrobial agent on the outer surface of the food products.

In another preferred embodiment method of killing and inhibiting microbial contamination of ready to eat meat and poultry products having an outer surface, an antimicrobial agent is applied to the outer surface of the ready to eat meat and poultry products. The ready to eat meat and poultry products are placed in packaging. The packaging is sealed under a vacuum so that the packaging contacts the ready to eat meat and poultry products and uniformly distributes the antimicrobial agent on the outer surface of the products and the antimicrobial agent is effective in preventing microbial contamination.

In another preferred embodiment method of killing and inhibiting microbial contamination of ready to eat meat and poultry products having an outer surface, cetylpyridinium chloride is applied to the outer surface of the ready to eat meat and poultry products. The cetylpyridinium chloride has a surface concentration of at least approximately 5,000 ppm and a product weight based concentration of at least approximately 22 ppm. The ready to eat meat and poultry products are placed in packaging, and the packaging is sealed under a vacuum so that the packaging contacts the ready to eat meat and poultry products and uniformly distributes the antimicrobial agent on the outer surface of the products.

### DETAILED DESCRIPTION OF THE PREFERRED EMBODIMENT

The present invention relates to the removal and inhibition of foodborne microbial growth, in particular Listeria monocytogenes, and the extension of product shelf life of ready to eat poultry and meat products by using antimicrobial agents. The present method may also be used on other types of food products to inhibit microbial growth. Several antimicrobial agents may be used including but not limited to CPC, ALTA-MATE, ALTA-2341, sodium diacetate, sodium lactate, liquid smoke, an herbal extract such as Flavonoid Mist™ manufactured by Arnhem, Incorporated, peroxyacetic acid, and Microsan™ manufactured by Inovatech. However, it is recognized that many other antimicrobial agents may also be used to inhibit microbial growth on various food products. In the preferred embodiment, the food products can be treated with antimicrobial agents in several ways by any method of applying the antimicrobial agents to the surface of the product. For example, one method of application is a spray mist directly onto the product surface just prior to packaging the product and then packaging the product aided by a vacuum to evenly distribute the formulation over the surface of the product. Another method of application is spraying the product with an electrostatic film coating as a fluidized powder or a liquid prior to vacuum packaging. Application could also be accomplished by passing the product through a cabinet that would apply a spray mist of fog of the formulation prior to vacuum packaging. Also, a slicing blade could be coated with an antimicrobial agent so that the antimicrobial agent is applied to the food product during slicing of the product thereby applying the antimicrobial agent between the slices of the product. Finally, the packaging material could be coated with a dry powder containing the antimicrobial agents or the antimicrobial agent could be incorporated directly into the packaging material prior to vacuum packaging. These methods are not exhaustive of how the antimicrobial agents could be applied to cooked, ready to eat products prior to vacuum packaging.

Contamination on cooked, ready to eat products usually occurs on the surface of the products and is usually the result of post-process contamination. With this in mind, the preferred embodiment does not incorporate the antimicrobial agents into the product formulation, which would require a much higher concentration of the antimicrobial agents on a product weight basis. In the preferred embodiment, the antimicrobial agent is applied in a method of application discussed above to the surface of the product in very high surface concentrations, up to 10,000 ppm when a 1% solution is used. This is a very high localized surface concentration providing excellent microbial kill, and yet the product weight based concentration is very low, in most cases less than 100 ppm. With large products having a higher mass to surface area ratio, this weight based concentration would be even lower yet. The method of application directed at the surface of the product in high concentrations provides an improved method of contacting the problem area of the meat products, with residual effect during refrigerated storage. Many products exhibit liquid purge during storage, providing an excellent growth medium for bacteria. The method of application would provide a way to treat purge with sufficient concentration of the antimicrobial agent to inhibit growth of the bacteria. Application of various other antimicrobial compounds in a similar fashion, where very high localized concentrations are necessary and yet low overall equilibrated weight based concentrations are desired or regulated, would also be effective. The method of application, resulting in low overall equilibrated concentrations, results in no detectable alteration in appearance, color, taste or texture of the products. Vacuum packaging by itself does not adequately inhibit the growth of bacteria during storage of the product.

The vacuum packaging ensures that the antimicrobial agent is uniformly distributed on the products and that contamination does not occur after the products have been packaged, and the vacuum level required is a level sufficient to cause the packaging to contact the product surface. During the tests, a liquid dye was used inside the package to indicate that the antimicrobial agent had been sufficiently spread around the surface of the product. Examples of sufficient vacuum bags and machine vacuum levels used during the tests are as follows: In a first example, a 3 MIL nylon/polyethylene vacuum pouch was used, and there were four meat franks per pouch weighing 227 grams in total. The machine vacuum was set at approximately 28 inches and sealed on a Multivac A300/16 machine. In a second example, a 2.4 MIL vacuum bag consisting of copolymers of ethylene and oxygen barriers of saran was used, and there were four meat franks per bag weighing 227 grams in total. The machine vacuum was set at approximately 28 inches and sealed on a Multivac A300/16 machine. However, it is recognized that the machine setting may vary depending upon the type of machine used, and the actual vacuum inside the package will vary by product size, shape, uniformity, texture, contour, etc.

Several lab tests were performed to determine the most effective concentrations of various antimicrobial agents. The tests focused on one particular microorganism, Listeria monocytogenes, and a cocktail of four strains of this organism was used in each test. The tests are explained in more detail below.

A first test used meat franks as media instead of a laboratory media. Additive solutions included CPC 0.05%, 0.5% and 5.0% and liquid smoke (ZESTI SMOKE® List-A-Smoke) having 0.36% active ingredient, 0.72% active ingredient and 1.08% active ingredient. These percentages were not based on meat weight but on the concentration in the liquid applied to the meat franks. The product weight based concentrations are shown in Tables 7-9. The solutions were made to the desired concentrations and then 1 ml was added to each product package. Four strains of Listeria monocytogenes were grown for approximately 18 hours in trypicase soy broth (“TSB”) at 35° C. Equal amounts of the cultures were mixed together and diluted to a final count of approximately 10⁴-10⁴ cfu/ml in sterile water, forming an inoculum. The franks were dipped in the inoculum for 1 minute and air dried in a bio-safety hood for approximately 2 minutes, turning the franks after each minute. The additives were applied to the surface of the inoculated product by misting 1 ml of various concentrations of each additive into a package of four franks. The package was then sealed under vacuum. All packages of franks were stored in a 4° C. incubator and taken out at various intervals to be tested. Several counts were run on day zero. Counts were run by adding 25 ml of BUTTERFIELDS, which is a phosphate buffer, per package. This was considered to be a 100 dilution. Then, 5 ml were removed for a spiral plate count and the remaining 20 ml was added to a University of Vermont media (“UVM”) pre-enrichment for a viable cell determination, a USDA FSIS procedure for Listeria monocytogenes. An inoculum count was run after dilution and before dipping the franks (pre-dip) and an inoculum count was run after dipping the franks (post-dip) to ensure that all tests received approximately the same amount of inoculum. The counts were run using modified oxford media (“MOX”) agar. Then, total plate count (“TPC”) and Listeria monocytogenes counts were run on the negative control (four franks in a package, uninoculated) using plate count agar (“PCA”) and MOX agar. TPC and Listeria monocytogenes counts were run on the positive control (four inoculated franks in a package without additive) using PCA and MOX agar. Finally, TPC and Listeria monocytogenes counts were run on each additive variable using PCA and MOX agar. Counts were repeated as above on a weekly basis, and the results of this test are shown in Table 1. Tables 7-9 show the results of this test measured in actual counts, log₁₀ counts, and log₁₀ reduction, respectively, and are discussed in more detail below.

TABLE 1
Survival/Growth of Listeria monocytogenes in Franks for Test 1

| | | | Viable | | | | Viable |
|---|---|---|---|---|---|---|---|
| Days | TPC | L.M. Count | Cells | Days | TPC | L.M. Count | Cells |
| 0.050% CPC | | | | 0.50% CPC | | | |
| 0 | 400 | 340 | Pos | 0 | <20 | <20 | Neg |
| 6 | 480 | 320 | Pos | 6 | <20 | <20 | Neg |
| 13 | 600 | 340 | Pos | 13 | >300,000 | <20 | Pos |
| 20 | 120 | 120 | Pos | 20 | >1,000,000 | <20 | Neg |
| 27 | 140 | 100 | Pos | 27 | >1,000,000 | <20 | Neg |
| 34 | >1,000,000 | 80 | Pos | 34 | >1,000,000 | 60 | Pos |
| 41 | <2,000 | 80 | Pos | 41 | >1,000,000 | 80 | Pos |
| 48 | <2,000 | <200 | Pos | 48 | 23,000,000 | <20 | Neg |
| | | | | 0.36% active ingredient | | | |
| 5.0% CPC | | | | Liquid Smoke | | | |
| 0 | <20 | <20 | Neg | 0 | 760 | 520 | Pos |
| 6 | <20 | <20 | Neg | 6 | >10,000 | 920 | Pos |
| 13 | <20 | <20 | Neg | 13 | >300,000 | 1,100 | Pos |
| 20 | <20 | <20 | Neg | 20 | >1,000,000 | 800 | Pos |
| 27 | 720,000 | <20 | Neg | | | | |
| 34 | 170,000 | <20 | Neg | | | | |
| 41 | 40,000 | <20 | Neg | | | | |
| 48 | 180,000 | <20 | Neg | | | | |
| 0.72% active ingredient | | | | 1.08% active ingredient | | | |
| Liquid Smoke | | | | Liquid Smoke | | | |
| 0 | 800 | 480 | Pos | 0 | 500 | 400 | Pos |
| 6 | >10,000 | 40 | Pos | 6 | >10,000 | 1,500 | Pos |
| 13 | >300,000 | 860 | Pos | 13 | >300,000 | 940 | Pos |
| 20 | >1,000,000 | 600 | Pos | 20 | >1,000,000 | 700 | Pos |

| Days | Negative Control | Days | Positive Control |
|---|---|---|---|
| 0 | <20-<20-Neg | 0 | 2,200-1,200-Pos |
| 6 | <20-<20-Neg | 6 | 4,400-3,000-Pos |
| 13 | 200,000-0-Neg | 13 | 20,000-19,000-Pos |
| 20 | <20-<20-Neg | 20 | 5,500-5,400-Pos |
| 27 | 120-<20-Neg | 27 | 5,000-5,200-Pos |
| 34 | <20-<20-Neg | 34 | 3,000-3,000-Pos |
| 41 | <20-<20-Neg | 41 | 2,400-300-Pos |
| 48 | Neg | 48 | Pos |

Inoculum Count (Pre-Dip) L. 32,000

(Post-Dip) L. 20,000

Table 1 shows the survival/growth of Listeria monocytogenes in franks over time after treatment with the additives CPC and liquid smoke. The shelf life of the product is indicated by the TPC results, and the viable cells data indicates whether viable Listeria monocytogenes cells were found over time after treatment with the additives. Positive results indicate that viable cells were found, and negative results indicate that viable cells were not found. For treatment with CPC, when a treatment of 1 ml of a 0.5% solution was used, Listeria monocytogenes was significantly reduced. When a treatment of 1 ml of a 5% solution was used, Listeria monocytogenes was completely eliminated.

A second test also used meat franks as media, but used the desired concentrations obtained from the third test. Additive solutions included CPC 1.0% and 3.0% and liquid smoke having 5.4% active ingredient (ZESTI SMOKE® List-A-Smoke) and 10% active ingredient (RED ARROW SMOKE—SPECIAL A). Four strains of Listeria monocytogenes were grown for approximately 18 hours in TSB at 35° C. Equal amounts of the cultures were mixed together and diluted to a final count of approximately 10³-10⁴ cfu/ml in sterile water, forming an inoculum. The franks were dipped in the inoculum for 1 minute and air dried in a bio-safety hood for approximately 2 minutes, turning the franks after each minute. Four franks were placed in each package and the additive solution was applied by a pipette as a liquid directly to the package at a rate of 2.0 ml per package. This equates to approximately 87 parts per million (“ppm”) for 1% CPC, 262 ppm for 3% CPC, 472 ppm for ZESTI SMOKE and 873 ppm for RED ARROW SMOKE—SPECIAL A, as shown in Tables 7-9. The packages were sealed under a vacuum. Several counts were run on day zero. Counts were run by adding 25 ml of BUTTERFIELDS per package, and this was considered to be a 100 dilution. Then, 5 ml were removed for a spiral plate count and the remaining 20 ml was added to a UVM pre-enrichment for a viable cell determination, a USDA FSIS procedure for Listeria monocytogenes. An inoculum count was run after dilution and before dipping the franks (pre-dip) and an inoculum count was run after dipping the franks (post-dip) to ensure that all tests received approximately the same amount of inoculum. The counts were run using MOX agar. Then, TPC and Listeria monocytogenes counts were run on the negative control (four franks in a package, uninoculated) using PCA and MOX agar. TPC and Listeria monocytogenes counts were run on the positive control (four inoculated franks in a package without additive) using PCA and MOX agar. Finally, TPC and Listeria monocytogenes counts were run on each additive variable using PCA and MOX agar. Counts were repeated as above on a weekly basis, and the results of this test are shown in Table 2 and Chart 1. Tables 7-9 show the results of this test measured in actual counts, log₁₀ counts, and log₁₀ reduction, respectively, and are discussed in more detail below.

TABLE 2
Survival/Growth of Listeria monocytogenes in Wranglers for Test 2

| | | | Viable | | | | Viable |
|---|---|---|---|---|---|---|---|
| Days | TPC | L.M. Count | Cells | Days | TPC | L.M. Count | Cells |
| | | | | 5.4% active ingredient | | | |
| 1% CPC | | | | List-A-Smoke - Zesti | | | |
| 0 | <20 | <20 | Neg | 0 | 640 | 120 | Pos |
| 6 | <20 | <20 | Neg | 6 | 9,600 | 600 | Pos |
| 13 | <20 | <20 | Neg | 13 | 1,000,000 | 600 | Pos |
| 20 | <20 | <20 | Neg | 20 | 6,600,000 | <20 | Pos |
| 27 | <20 | <20 | Neg | 27 | >10,000,000 | 1,200 | Pos |
| 34 | <20 | <20 | Neg | 34 | >10,000,000 | 1,800 | Pos |
| 41 | <20 | <20 | Neg | 41 | 43,000,000 | 600 | Pos |
| 48 | <20 | <20 | Neg | 48 | 19,000,000 | 600 | Pos |
| | | | | 10% active ingredient | | | |
| | | | | Liquid Smoke Special A - Red | | | |
| 3% CPC | | | | Arrow | | | |
| 0 | <20 | <20 | Neg | 0 | 600 | 100 | Pos |
| 6 | <20 | <20 | Neg | 6 | 60 | 100 | Pos |
| 13 | <20 | <20 | Neg | 13 | 7,500 | <20 | Pos |
| 20 | <20 | <20 | Neg | 20 | 80 | 60 | Pos |
| 27 | <20 | <20 | Neg | 27 | >10,000,000 | 4,000 | Pos |
| 34 | <20 | <20 | Neg | 34 | >10,000,000 | 10,000 | Pos |
| 41 | <20 | <20 | Neg | 41 | 15,000,000 | 470,000 | Pos |
| 48 | <20 | <20 | Neg | 48 | 29,000,000 | 110,000 | Pos |
| Regular Packaged Wrangler | | | | | | | |
| Days | APC | L.M. Count | VC | | | | |
| 13 | 150,000 | <20 | Neg | | | | |
| 20 | 24,000 | <20 | Neg | | | | |
| 27 | 37,000 | <20 | Neg | | | | |
| Negative Control | | | | Positive Control | | | |
| | | | Viable | | | | Viable |
| Days | TPC | L.M. Count | Cells | Days | TPC | L.M. Count | Cells |
| 0 | <20 | <20 | Neg | 0 | 2,600 | 1,200 | Pos |
| 6 | >1,000,000 | <20 | Neg | 6 | >1,000,000 | 210,000 | Pos |
| 13 | >1,000,000 | <20 | Neg | 13 | >1,000,000 | 110,000 | Pos |
| 20 | 27,000,000 | <20 | Neg | 20 | 18,000,000 | 230,000 | Pos |
| 27 | >10,000,000 | <20 | Neg | 27 | >10,000,000 | 330,000 | Pos |
| 34 | >10,000,000 | <20 | Neg | 34 | >10,000,000 | 740,000 | Pos |
| 41 | 60,000,000 | <20 | Neg | 41 | 67,000,000 | 1,900,000 | Pos |
| 48 | 74,000,000 | <20 | Neg | 48 | 12,000,000 | 4,200,000 | Pos |

Inoculum Count (Pre-Dip) L. 41,000

(Post-Dip) L. 39,000

Table 2 shows the survival/growth of Listeria monocytogenes in franks over time after treatment with the additives CPC and liquid smoke. The shelf life of the product is indicated by the TPC results, and the viable cells data indicates whether viable Listeria monocytogenes cells were found over time after treatment with the additives. Positive results indicate that viable cells were found, and negative results indicate that no viable cells were found. For treatment with CPC, the results indicate that using 2.0 ml of a 1% solution and using 2.0 ml of a 3% solution were very effective in controlling Listeria monocytogenes because the counts were less than 20 from 0-48 days and no viable cells were found. The results also indicate a positive effect on extended shelf life of the product because the TPC was <20 for days 0-48. For treatment with liquid smoke, a bacteriostatic effect against Listeria monocytogenes was demonstrated throughout the 48 days of storage.

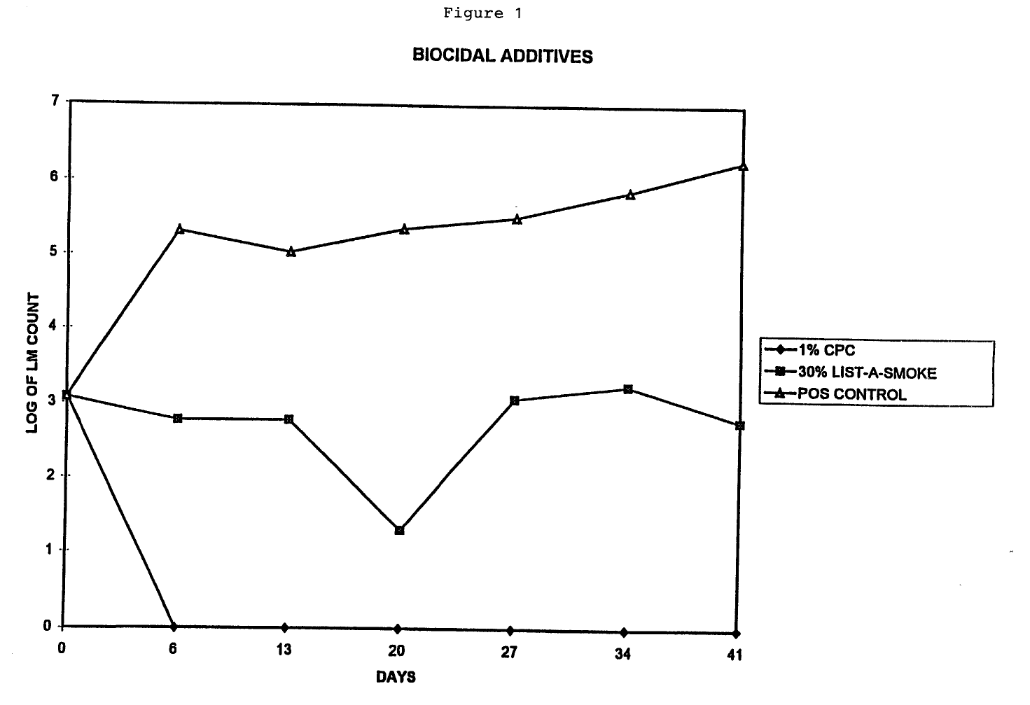

FIG. 1 shows the log₁₀ of the Listeria monocytogenes count over a period of 41 days after treatment with 1% CPC, 5.4% active ingredient ZESTI SMOKE® List-A-Smoke, and a positive control. After just 6 days, the count is reduced by 3 logs after treatment with CPC, the count is reduced slightly after treatment with ZESTI SMOKE® List-A-Smoke, and the count increased more than 2 logs in the positive control.

In a third test, CPC was applied to the surface of large whole muscle products such as deli turkey breast, beef logs, and pork deli roasts each weighing eight pounds. The variables tested included 1% CPC with JENNIE-O® Turkey Breast, DAN'S PRIZE® Beef Log, and DAN'S PRIZE® Pork Deli Roast and positive tests with JENNIE-O® Turkey Breast, DAN'S PRIZE® Beef Log, and DAN'S PRIZE® Pork Deli Roast. Four strains of Listeria monocytogenes were grown for approximately 18 hours in TSB at 35° C. Equal amounts of the cultures were mixed together and diluted to a final count of approximately 10³-10⁴ cfu/ml in sterile water, forming an inoculum. The products were split in half and one half was used for the positive control and the other half was used for the CPC test. The positive test products and the CPC test products were dipped in the inoculum for one minute and air dried in a bio-safety hood for two minutes, turning the products after each minute. Each half of the product was placed in one package. For the positive control, 10.0 ml of sterile water was misted onto the entire product surface. A treatment of 10.0 ml of a 1% CPC solution was misted onto the entire product surface which is approximately 55 ppm based on the total product weight. The packages were sealed under a vacuum. All packages were stored in a 4° C. incubator and removed at various intervals to be tested. Several counts were run on day zero. Counts were run by adding 100 ml of BUTTERFIELDS per package, and this was considered to be a 100 dilution. Then, 5 ml were removed for a spiral plate count and 25 ml was added to a 225 ml UVM pre-enrichment for a viable cell determination, a USDA FSIS procedure for Listeria monocytogenes. An inoculum count was run after dilution and before dipping the products (pre-dip) and an inoculum count was run after dipping the products (post-dip) to ensure that all tests received approximately the same amount of inoculum. The counts were run using MOX agar. TPC and Listeria monocytogenes counts were run on the positive test products and the CPC test products using PCA and MOX agar. The counts were repeated as above at 14, 28 and 42 days. As shown in Table 3, the results of this test were also very encouraging. Tables 7-9 show the results of this test measured in actual counts, log₁₀ counts, log₁₀ reduction, respectively, and are discussed in more detail below.

TABLE 3
Survival/Growth of Listeria monocytogenes for Test 3

| | | L.M. | Viable | | | Viable |
|---|---|---|---|---|---|---|
| Days | TPC | Count | Cells | TPC | L.M. Count | Cells |
| CPC | | | | Positive Control - J-O Turkey | | |
| 1% - J-O Turkey Breast | | | | Breast | | |
| 0 | <20 | <20 | Neg | 1,800 | 640 | Pos |
| 14 | 44,000 | <20 | Neg | 100,000 | 81,000 | Pos |
| 28 | 41,000 | <20 | Neg | >100,000 | 790,000 | Pos |
| CPC 1% - | | | | Positive | | |
| D.P. Beef Log | | | | Control - D.P. Beef Log | | |
| 0 | <20 | <20 | Neg | 20,000 | 980 | Pos |
| 14 | 96,000 | <20 | * | >100,000 | 300 | Pos |
| 28 | 40,000 | <20 | Neg | >100,000 | 300 | Pos |
| CPC 1% - D.P. | | | | Positive Control - D.P. | | |
| Pork Deli Roast | | | | Pork Deli Roast | | |
| 0 | <20 | <20 | Neg | 26,000 | 1,000 | Pos |
| 14 | 44,000 | <20 | * | 100,000 | 400 | Pos |
| 28 | 34,000 | <20 | * | >100,000 | 140 | Pos |

*Surface was negative, viable cell(s) were found subsurface

Inoculum Count (Pre-Dip) L. 38,000 (Post-Dip) L. 22,000

Table 3 shows the survival/growth of Listeria monocytogenes in turkey, beef, and pork over time after treatment with 1% CPC. Again, the shelf life of the product is indicated by the TPC results, and the viable cells data indicates whether viable Listeria monocytogenes cells were found over time after treatment with the additives. Positive results indicate that viable cells were found, and negative results indicate that no viable cells were found. For treatment with 1% CPC, the count was very low (less than 20), no viable cells were found on the surface, and the shelf life was extended for the turkey, the beef, and the pork.

In a fourth test, four strains of Listeria monocytogenes were grown overnight in TSB at 35° C. Equal amounts of the four strains were mixed and diluted to a final count of approximately 10³-10⁴ cfu/ml in sterile water. Franks were dipped in the inoculum for one minute and air dried in a bio-safety hood for two minutes, turning after each minute. The negative control franks were not dipped in inoculum. Four franks were placed in each bag. The additives tested were Flavonoid Mist (2 ml of a 0.3% active ingredient solution of oil extract), Flavonoid Mist (0.4 grams of a dry powder extract type F-900; 5% active ingredient in the powder), a positive control, and a negative repackaged control. In the case of the 0.3% active ingredient additive solution, 2.0 ml of the 0.3% active ingredient additive solution to be tested was placed into each of the bags using a pipette. In the case of the dry powder, 0.4 grams of powder having 0.02% active ingredient was placed into each of the bags and distributed evenly around the inside of the bags and on the franks. 2.0 ml of sterile water was added to the positive and negative controls. Then, the bags were sealed under vacuum. On day “0,” pre-dip and post-dip Listeria monocytogenes counts were run on the diluted inoculum using MOX agar. TPC and Listeria monocytogenes counts were run on control samples and Flavonoid Mist treated samples using PCA and MOX agar. These counts were run by adding 25 ml of BUTTERFIELDS per bag, and this was considered a 100 dilution. 5 ml was removed for the spiral plate count, and 20 ml was added to a 225 ml UVM pre-enrichment for a viable cell determination. All packages of products were stored in 4° C. incubator and pulled out at various intervals to be tested. Counts were repeated at 7, 14, 21, 28, 35, 42, and 49 days. Counts were repeated as above on a weekly basis, and the results of this test are shown in Table 4. Tables 7-9 show the results of this test measured in actual counts, log₁₀ counts, and log₁₀ reduction, respectively, and are discussed in more detail below.

TABLE 4
Survival/Growth of Listeria monocytogenes
in Wranglers for Test 4

| | | L.M. | Viable | | L.M. | Viable |
|---|---|---|---|---|---|---|
| Days | TPC | Count | Cells | TPC | Count | Cells |
| 0.3% active ingredient | | | | 0.02% active ingredient | | |
| Flavonoid Mist | | | | Flavonoid Dry | | |
| 0 | 200 | 200 | Pos | 100 | 100 | Pos |
| 7 | 1,400 | 1,000 | Pos | 400 | 260 | Pos |
| 14 | 18,000 | 18,000 | Pos | 140 | 60 | Pos |
| 21 | 33,000 | 23,000 | Pos | 18,000 | 10,000 | Pos |
| 28 | 120,000 | 120,000 | Pos | 290 | 40 | Pos |
| 35 | >10⁵ | <10⁵ | Pos | 27,000 | 12,000 | Pos |
| 42 | >10⁵ | >10⁵ | Pos | 30,000 | 20,000 | Pos |
| Negative Control | | | | Positive Control | | |
| 0 | <20 | <20 | Neg | 3,700 | 3,300 | Pos |
| 7 | <20 | <20 | Neg | 5,500 | 4,200 | Pos |
| 14 | <20 | <20 | Neg | 37,000 | 30,000 | Pos |
| 21 | <20 | <20 | Neg | 130,000 | 97,000 | Pos |
| 28 | <20 | <20 | Neg | 160,000 | 160,000 | Pos |
| 35 | <20 | <20 | Neg | >10⁵ | >10⁵ | Pos |
| 42 | <20 | <20 | Neg | >10⁵ | >10⁵ | Pos |

Inoculum Count (Pre-Dip) L. 50.000 (Post-Dip) L. 66,000

Table 4 shows the survival/growth of Listeria monocytogenes in franks over time after treatment with the additives 0.3% active ingredient Flavonoid Mist and Flavonoid Mist in a powder form. The shelf life of the product is indicated by the TPC results, and the viable cells data indicates whether viable Listeria monocytogenes cells were found over time after treatment with the additives. Positive results indicate that viable cells were found, and negative results indicate that no viable cells were found. For treatment with 0.3% active ingredient Flavonoid Mist, some bacteriostatic effect was noted. For treatment with Flavonoid Mist in powder form, a significant bacteriostatic effect was noted.

In a fifth test, four strains of Listeria monocytogenes were grown overnight in TSB at 35° C. Equal amounts of the four strains were mixed and diluted to a final count of approximately 10³-10⁴ cfu/ml in sterile water. Franks were dipped in the inoculum for one minute and air dried in a bio-safety hood for two minutes, turning after each minute. Negative control franks were not dipped in inoculum. Four franks were placed in each bag. The additives tested were Flavonoid Mist (2 ml of a 2.1% active ingredient solution of oil extract), Flavonoid Mist (2 ml of a 4.5% active ingredient solution of oil extract), Flavonoid Mist (2 ml of a 15% active ingredient solution of oil extract), a positive control, and a negative repackaged control. 2.0 ml of the additive solutions was added to the bags using a pipette, and 2.0 ml of sterile water was added for the positive and negative controls. The bags were sealed under vacuum. On day “0,” Listeria monocytogenes pre-dip and post-dip counts were run on the diluted inoculum using MOX agar. TPC and Listeria monocytogenes counts were run on the control samples and Flavonoid Mist treated samples using PCA and MOX agar. These counts were run by adding 25 ml of BUTTERFIELDS per bag, and this was considered to be a 100 dilution. 5 ml was removed for the spiral place count, and 20 ml was added to a 225 ml UVM pre-enrichment for a viable cell determination. All the packages of product were stored in a 4° C. incubator and pulled out at various intervals to be tested. Counts were repeated at 7, 14, 21, 28, 35, 42, and 49 days. Counts were repeated as above on a weekly basis, and the results of this test are shown in Table 5. Tables 7-9 show the results of this test measured in actual counts, log₁₀ counts, and log₁₀ reduction, respectively, and are discussed in more detail below.

TABLE 5
Survival/Growth of Listeria monocytogenes
in Wranglers for Test 5

| | | L.M. | Viable | | | Viable |
|---|---|---|---|---|---|---|
| Days | TPC | Count | Cells | TPC | L.M. Count | Cells |
| Negative Control | | | | Positive Control | | |
| 0 | <20 | <20 | Neg | 7,100 | 7,100 | Pos |
| 7 | <20 | <20 | Neg | 6,000 | 2,800 | Pos |
| 14 | <20 | <20 | Neg | 32,000 | 27,000 | Pos |
| 21 | <20 | <20 | Neg | 1,000,000 | 1,000,000 | Pos |
| 23 | <20 | <20 | Neg | | | |
| 28 | <20 | <20 | Neg | 15,000,000 | 5,900,000 | Pos |
| 35 | <20 | <20 | Neg | 180,000,000 | 40,000,000 | Pos |
| 42 | <20 | <20 | Neg | 81,000,000 | 33,000,000 | Pos |
| 2.1% active ingredient | | | | 4.5% active ingredient | | |
| Flavonoid Mist | | | | Flavonoid Mist | | |
| 0 | <20 | <20 | Neg | <20 | <20 | Neg |
| 7 | <20 | <20 | Neg | <20 | <20 | Neg |
| 14 | <20 | <20 | Neg | <20 | <20 | Neg |
| 21 | <20 | <20 | Neg | <20 | <20 | Neg |
| 28 | <20 | <20 | Neg | <20 | <20 | Neg |
| 35 | <20 | <20 | Neg | <20 | <20 | Neg |
| 42 | <20 | <20 | Neg | <20 | <20 | Neg |

| 15% active ingredient | | | |
|---|---|---|---|
| Flavonoid Mist | | | |
| 0 | <20 | <20 | Neg |
| 7 | <20 | <20 | Neg |
| 14 | <20 | <20 | Neg |
| 21 | <20 | <20 | Neg |
| 28 | <20 | <20 | Neg |
| 35 | <20 | <20 | Neg |
| 42 | <20 | <20 | Neg |

Inoculum Count (Pre-Dip) L. 64,000 (Post-Dip) L. 96,000

Table 5 shows the survival/growth of Listeria monocytogenes in franks over time after treatment with the additives 2.1% active ingredient Flavonoid Mist, 4.5% active ingredient Flavonoid Mist, and 15% active ingredient Flavonoid Mist. The shelf life of the product is indicated by the TPC results, and the viable cells data indicates whether viable Listeria monocytogenes cells were found over time after treatment with the additives. Positive results indicate that viable cells were found, and negative results indicate that no viable cells were found. For treatment with the 2.1% active ingredient, 4.5% active ingredient, and 15% active ingredient Flavonoid Mist, the Listeria monocytogenes count was less than 20, no viable cells were found, and the TPC was less than 20 from days 0-42. Therefore, these concentrations of Flavonoid Mist were effective in controlling Listeria monocytogenes and extending the shelf life of the product.

Finally, in a sixth test, four strains of Listeria monocytogenes were grown overnight in TSB at 35° C. Equal amounts of the four strains were mixed and diluted to a final count of approximately 10³-10⁴ cfu/ml in sterile water. Franks were dipped in the inoculum for one minute and air dried in a bio-safety hood for two minutes, turning after each minute. The negative control franks were not dipped in inoculum. Four franks were placed in each bag. The additives tested were Flavonoid Mist (2 ml of a 0.6% active ingredient solution of oil extract), Flavonoid Mist (2 ml of a 0.9% active ingredient solution of oil extract), Flavonoid Mist (2 ml of a 1.2% active ingredient solution of oil extract), Flavonoid Mist (2 ml of a 1.5% active ingredient solution of oil extract), Flavonoid Mist (2 ml of a 1.8% active ingredient solution of oil extract), a positive control, and a negative repackaged control. 2.0 ml of the additive solution was placed in each bag using a pipette, and 2.0 ml of sterile water was used for the positive and negative controls. The bags were then sealed under vacuum. On day “0,” Listeria monocytogenes pre-dip and post-dip counts were run on diluted inoculum using MOX agar. TPC and Listeria monocytogenes counts were run on the control samples and the Flavonoid Mist treated samples using PCA and MOX agar. These counts were run by adding 25 ml of BUTTERFIELDS per bag, and this was considered a 10⁰ dilution. 5 ml was removed for the spiral plate count, and 20 ml was added to a 225 ml UVM pre-enrichment for a viable cell determination. All the packages of product were stored in a 4° C. incubator and pulled out at various intervals to be tested. Counts were repeated at 7, 14, 21, 28, 35, 42, and 49 days. Counts were repeated as above on a weekly basis, and the results of this test are shown in Table 6. Tables 7-9 show the results of this test measured in actual counts, log₁₀ counts, and log₁₀ reduction, respectively, and are discussed in more detail below.

TABLE 6
Survival/Growth of Listeria monocytogenes
in Wranglers for Test 6

| | | L.M. | Viable | | L.M. | Viable |
|---|---|---|---|---|---|---|
| Days | TPC | Count | Cells | TPC | Count | Cells |
| | | | | 0.6% active ingredient | | |
| Negative Control | | | | Flavonoid Mist | | |
| 0 | <20 | <20 | Neg | <20 | <20 | Neg |
| 7 | <20 | <20 | Neg | 700 | 600 | Pos |
| 14 | <20 | <20 | Neg | 900 | 700 | Pos |
| 21 | <20 | <20 | Neg | 88,000 | 88,000 | Pos |
| 28 | <20 | <20 | Neg | 21,000,000 | 2,800,000 | Pos |
| 0.9% active ingredient | | | | 1.2% active ingredient | | |
| Flavonoid Mist | | | | Flavonoid Mist | | |
| 0 | <20 | <20 | Neg | <20 | <20 | Neg |
| 7 | 100 | 100 | Pos | <20 | <20 | Neg |
| 14 | 1,900 | 800 | Pos | 600 | <20 | Neg |
| 21 | 140,000 | 100,000 | Pos | 31,000 | 20,000 | Pos |
| 28 | 3,200,000 | 1,800,000 | Pos | 4,900,000 | 1,700,000 | Pos |
| 1.5% active ingredient | | | | 1.8% active ingredient | | |
| Flavonoid Mist | | | | Flavonoid Mist | | |
| 0 | <20 | <20 | Neg | <20 | <20 | Neg |
| 7 | <20 | <20 | Neg | <20 | <20 | Neg |
| 14 | <20 | <20 | Neg | <20 | <20 | Neg |
| 21 | 23,000 | 23,000 | Pos | 5,200 | 5,200 | Pos |
| 28 | 11,000,000 | 1,300,000 | Pos | 72,000 | 41,000 | Pos |

| Positive Control | | | |
|---|---|---|---|
| 0 | 3,100 | 2,800 | Pos |
| 7 | 7,100 | 6,500 | Pos |
| 14 | 160,000 | 30,000 | Pos |
| 21 | 200,000 | 180,000 | Pos |
| 28 | 14,000,000 | 14,000,000 | Pos |

Inoculum Count (Pre-Dip) L. 62,000 (Post-Dip) L. 77,000

Table 6 shows the survival/growth of Listeria monocytogenes in franks over time after treatment with the additives 0.6% active ingredient Flavonoid Mist, 0.9% active ingredient Flavonoid Mist, 1.2% active ingredient Flavonoid Mist, 1.5% active ingredient Flavonoid Mist, and 1.8% active ingredient Flavonoid Mist. The shelf life of the product is indicated by the TPC results, and the viable cells data indicates whether viable Listeria monocytogenes cells were found over time after treatment with the additives. Positive results indicate that viable cells were found, and negative results indicate that no viable cells were found. For treatment with the 0.6% active ingredient and 0.9% active ingredient Flavonoid Mist, the Listeria monocytogenes count was greater and more viable cells were found than with the 1.2% active ingredient, 1.5% active ingredient, and 1.8% active ingredient Flavonoid Mist. For days 0-14, the Listeria monocytogenes count was less than 20 and no viable cells were found after treatment with 1.2% active ingredient, 1.5% active ingredient, and 1.8% active ingredient Flavonoid Mist. Therefore, 1.2% active ingredient, 1.5% active ingredient, and 1.8% active ingredient Flavonoid Mist were effective in controlling Listeria monocytogenes and extending the shelf life of the product.

Tables 7-9 are shown below. Table 7 summarizes the actual count of Listeria monocytogenes for tests 1-6. Table 8 presents this data as log₁₀ values. Table 9 presents this data as a log₁₀ reduction from the positive control. These tables provide additional information on product weight in grams, the concentration of the active ingredient added in ppm, and the concentration of the active ingredient per the product weight in ppm. This additional information supports the conclusion that low doses of antimicrobial agents are very effective in killing and inhibiting the growth of organisms over time using the present method.

TABLE 7
Survival/Growth of Listeria monocytogenes
Actual Counts

| | | | | | Conc. |
|---|---|---|---|---|---|
| | | Amount | | Conc. | Active |
| | | Added | | Active | Ingr. Per |
| | | Per | Product | Ingr. | Product |
| Test | | Pkg | Weight | Added | Weight |
| No. | Additive | (ml) | (gm) | (ppm) | (ppm) |
| 1 | CPC | 1.0 | 227 | 500 | 2 |
| 1 | CPC | 1.0 | 227 | 5,000 | 22 |
| 1 | CPC | 1.0 | 227 | 50,000 | 220 |
| 1 | Liq. Smk | 1.0 | 227 | 3,600 | 16 |
| | (Zesti) | | | | |
| 1 | Liq. Smk | 1.0 | 227 | 7,200 | 32 |
| | (Zesti) | | | | |
| 1 | Liq. Smk | 1.0 | 227 | 10,800 | 47 |
| | (Zesti) | | | | |
| 2 | CPC | 2.0 | 227 | 10,000 | 87 |
| 2 | CPC | 2.0 | 227 | 30,000 | 262 |
| 2 | Liq. Smk | 2.0 | 227 | 54,000 | 472 |
| | (Zesti) | | | | |
| 2 | Liq. Smk | 2.0 | 227 | 100,000 | 873 |
| | (Red | | | | |
| | Arrow) | | | | |
| 3 | CPC | 10.0 | 1816 | 10,000 | 55 |
| | (Turkey) | | | | |
| 3 | CPC | 10.0 | 1816 | 10,000 | 55 |
| 3 | CPC | 10.0 | 1816 | 10,000 | 55 |
| 4 | Flavonoid | 2.0 | 227 | 3,000 | 26 |
| | Mist | | | | |
| 4 | Flavonoid | 0.4 gm | 227 | 200 | 0.4 |
| | Mist (Dry) | | | | |
| 5 | Flavonoid | 2.0 | 227 | 21,000 | 183 |
| | Mist | | | | |
| 5 | Flavonoid | 2.0 | 227 | 45,000 | 393 |
| | Mist | | | | |
| 5 | Flavonoid | 2.0 | 227 | 150,000 | 1,310 |
| | Mist | | | | |
| 6 | Flavonoid | 2.0 | 227 | 6,000 | 52 |
| | Mist | | | | |
| 6 | Flavonoid | 2.0 | 227 | 9,000 | 79 |
| | Mist | | | | |
| 6 | Flavonoid | 2.0 | 227 | 12,000 | 105 |
| | Mist | | | | |
| 6 | Flavonoid | 2.0 | 227 | 15,000 | 131 |
| | Mist | | | | |
| 6 | Flavonoid | 2.0 | 227 | 18,000 | 157 |
| | Mist | | | | |

| Test | | 0 | 6 | 13 | 20 | 27 | 34 | 41 | 48 |
|---|---|---|---|---|---|---|---|---|---|
| No. | Additive | Days | Days | Days | Days | Days | Days | Days | Days |
| 1 | CPC | 340 | 320 | 340 | 120 | 100 | 80 | 80 | <200 |
| 1 | CPC | <20 | <20 | <20 | <20 | <20 | 60 | 80 | <20 |
| 1 | CPC | <20 | <20 | <20 | <20 | <20 | <20 | <20 | <20 |
| 1 | Liq. Smk | 520 | 920 | 1,100 | 800 | | | | |
| | Zesti | | | | | | | | |
| 1 | Liq. Smk | 480 | 40 | 860 | 600 | | | | |
| | (Zesti) | | | | | | | | |
| 1 | Liq. Smk | 400 | 1,500 | 940 | 700 | | | | |
| | (Zesti) | | | | | | | | |
| 2 | CPC | <20 | <20 | <20 | <20 | <20 | <20 | <20 | <20 |
| 2 | CPC | <20 | <20 | <20 | <20 | <20 | <20 | <20 | <20 |
| 2 | Liq. Smk | 120 | 600 | 600 | <20 | 1,200 | 1,800 | 600 | 600 |
| | (Zesti) | | | | | | | | |
| 2 | Liq. Smk | 100 | 100 | <20 | 60 | 4,000 | 10,000 | 470,000 | 110,000 |
| | (Red | | | | | | | | |
| | Arrow) | | | | | | | | |

| Test | | 0 | 7 | 14 | | | | |
|---|---|---|---|---|---|---|---|---|
| No. | Additive | Days | Days | Days | 21 Days | 28 Days | 35 Days | 42 Days |
| 3 | CPC | <20 | | <20 | | <20 | | <20 |
| | (Turkey) | | | | | | | |
| 3 | CPC | <20 | | <20 | | <20 | | <20 |
| | (Beef) | | | | | | | |
| 3 | CPC | <20 | | <20 | | <20 | | <20 |
| | (Pork) | | | | | | | |
| 4 | Flavonoid | 200 | 1,000 | 18,000 | 23,000 | 120,000 | >100,000 | >100,000 |
| | Mist | | | | | | | |
| 4 | Flavonoid | 100 | 260 | 60 | 10,000 | 40 | 12,000 | 20,000 |
| | Mist (Dry) | | | | | | | |
| 5 | Flavonoid | <20 | <20 | <20 | <20 | <20 | <20 | <20 |
| | Mist | | | | | | | |
| 5 | Flavonoid | <20 | <20 | <20 | <20 | <20 | <20 | <20 |
| | Mist | | | | | | | |
| 5 | Flavonoid | <20 | <20 | <20 | <20 | <20 | <20 | <20 |
| | Mist | | | | | | | |
| 6 | Flavonoid | <20 | 600 | 700 | 80,000 | 2,800,000 | | |
| | Mist | | | | | | | |
| 6 | Flavonoid | <20 | 100 | 800 | 100,000 | 1,800,000 | | |
| | Mist | | | | | | | |
| 6 | Flavonoid | <20 | <20 | <20 | 20,000 | 1,700,000 | | |
| | Mist | | | | | | | |
| 6 | Flavonoid | <20 | <20 | <20 | 23,000 | 1,300,000 | | |
| | Mist | | | | | | | |
| 6 | Flavonoid | <20 | <20 | <20 | 5,200 | 41,000 | | |
| | Mist | | | | | | | |

TABLE 8
Survival/Growth of Listeria monocytogenes
Log₁₀ Counts

| | | | | | Conc. |
|---|---|---|---|---|---|
| | | Amount | | Conc. | Active |
| | | Added | | Active | Ingr. Per |
| | | Per | Product | Ingr. | Product |
| Test | | Pkg | Weight | Added | Weight |
| No. | Additive | (ml) | (gm) | (ppm) | (ppm) |
| 1 | CPC | 1.0 | 227 | 500 | 2 |
| 1 | CPC | 1.0 | 227 | 5,000 | 22 |
| 1 | CPC | 1.0 | 227 | 50,000 | 220 |
| 1 | Liq. Smk | 1.0 | 227 | 3,600 | 16 |
| | (Zesti) | | | | |
| 1 | Liq. Smk | 1.0 | 227 | 7,200 | 32 |
| | (Zesti) | | | | |
| 1 | Liq. Smk | 1.0 | 227 | 10,800 | 47 |
| | (Zesti) | | | | |
| 2 | CPC | 2.0 | 227 | 10,000 | 87 |
| 2 | CPC | 2.0 | 227 | 30,000 | 262 |
| 2 | Liq. Smk | 2.0 | 227 | 54,000 | 472 |
| | (Zesti) | | | | |
| 2 | Liq. Smk | 2.0 | 227 | 100,000 | 873 |
| | (Red | | | | |
| | Arrow) | | | | |
| 3 | CPC | 10.0 | 1816 | 10,000 | 55 |
| | (Turkey) | | | | |
| 3 | CPC | 10.0 | 1816 | 10,000 | 55 |
| | (Beef) | | | | |
| 3 | CPC | 10.0 | 1816 | 10,000 | 55 |
| | (Pork) | | | | |
| 4 | Flavonoid | 2.0 | 227 | 3,000 | 26 |
| | Mist | | | | |
| 4 | Flavonoid | 0.4 gm | 227 | 200 | 0.4 |
| | Mist (Dry) | | | | |
| 5 | Flavonoid | 2.0 | 227 | 21,000 | 183 |
| | Mist | | | | |
| 5 | Flavonoid | 2.0 | 227 | 45,000 | 393 |
| | Mist | | | | |
| 5 | Flavonoid | 2.0 | 227 | 150,000 | 1,310 |
| | Mist | | | | |
| 6 | Flavonoid | 2.0 | 227 | 6,000 | 52 |
| | Mist | | | | |
| 6 | Flavonoid | 2.0 | 227 | 9,000 | 79 |
| | Mist | | | | |
| 6 | Flavonoid | 2.0 | 227 | 12,000 | 105 |
| | Mist | | | | |
| 6 | Flavonoid | 2.0 | 227 | 15,000 | 131 |
| | Mist | | | | |
| 6 | Flavonoid | 2.0 | 227 | 18,000 | 157 |
| | Mist | | | | |

| Test | | 0 | 6 | 13 | 20 | 27 | 34 | 41 | 48 |
|---|---|---|---|---|---|---|---|---|---|
| No. | Additive | Days | Days | Days | Days | Days | Days | Days | Days |
| 1 | CPC | 2.53 | 2.51 | 2.53 | 2.08 | 2.00 | 1.90 | 1.90 | 2.30 |
| 1 | CPC | 0.00 | 0.00 | 1.30 | 0.00 | 0.00 | 1.78 | 1.90 | 0.00 |
| 1 | CPC | 0.00 | 0.00 | 0.00 | 0.00 | 0.00 | 0.00 | 0.00 | 0.00 |
| 1 | Liq. Smk | 2.72 | 2.96 | 3.04 | 2.90 | | | | |
| | (Zesti) | | | | | | | | |
| 1 | Liq. Smk | 2.68 | 1.60 | 2.93 | 2.78 | | | | |
| | (Zesti) | | | | | | | | |
| 1 | Liq. Smk | 2.60 | 3.18 | 2.97 | 2.85 | | | | |
| | Zesti | | | | | | | | |
| 2 | CPC | 0.00 | 0.00 | 0.00 | 0.00 | 0.00 | 0.00 | 0.00 | 0.00 |
| 2 | CPC | 0.00 | 0.00 | 0.00 | 0.00 | 0.00 | 0.00 | 0.00 | 0.00 |
| 2 | Liq. Smk | 2.08 | 2.78 | 2.78 | 1.30 | 3.08 | 3.26 | 2.78 | 2.78 |
| | (Zesti) | | | | | | | | |
| 2 | Liq. Smk | 2.00 | 2.00 | 1.30 | 1.78 | 3.60 | 4.00 | 5.67 | 5.04 |
| | (Red | | | | | | | | |
| | Arrow) | | | | | | | | |

| Test | | 0 | 7 | | | | | |
|---|---|---|---|---|---|---|---|---|
| No. | Additive | Days | Days | Days | 21 Days | 28 Days | 35 Days | 42 Days |
| 3 | CPC | 0.00 | | 0.00 | | 0.00 | | 0.00 |
| | (Turkey) | | | | | | | |
| 3 | CPC | 0.00 | | 1.30 | | 0.00 | | 1.30 |
| | (Beef) | | | | | | | |
| 3 | CPC | 0.00 | | 1.30 | | 1.30 | | 1.30 |
| | (Pork) | | | | | | | |
| 4 | Flavonoid | 2.30 | 3.00 | 4.26 | 4.36 | 5.08 | 5.00 5.00 | |
| | Mist | | | | | | | |
| 4 | Flavonoid | 2.00 | 2.41 | 1.78 | 4.00 | 1.60 | 4.08 4.30 | |
| | Mist (Dry) | | | | | | | |
| 5 | Flavonoid | 0.00 | 0.00 | 0.00 | 0.00 | 0.00 | 0.00 | 0.00 |
| | Mist | | | | | | | |
| 5 | Flavonoid | 0.00 | 0.00 | 0.00 | 0.00 | 0.00 | 0.00 | 0.00 |
| | Mist | | | | | | | |
| 5 | Flavonoid | 0.00 | 0.00 | 0.00 | 0.00 | 0.00 | 0.00 | 0.00 |
| | Mist | | | | | | | |
| 6 | Flavonoid | 0.00 | 2.78 | 2.85 | 4.90 | 6.45 | | |
| | Mist | | | | | | | |
| 6 | Flavonoid | 0.00 | 2.00 | 2.90 | 5.00 | 6.26 | | |
| | Mist | | | | | | | |
| 6 | Flavonoid | 0.00 | 0.00 | 0.00 | 4.30 | 6.23 | | |
| | Mist | | | | | | | |
| 6 | Flavonoid | 0.00 | 0.00 | 0.00 | 4.36 | 6.11 | | |
| | Mist | | | | | | | |
| 6 | Flavonoid | 0.00 | 0.00 | 0.00 | 3.72 | 4.61 | | |
| | Mist | | | | | | | |

TABLE 9
Survival/Growth of Listeria monocytogenes
Log₁₀ Reduction (Control - Test)

| | | | | | Conc. |
|---|---|---|---|---|---|
| | | Amount | | Conc. | Active |
| | | Added | | Active | Ingr. Per |
| | | Per | Product | Ingr. | Product |
| Test | | Pkg | Weight | Added | Weight |
| No. | Additive | (ml) | (gm) | (ppm) | (ppm) |
| 1 | CPC | 1.0 | 227 | 500 | 2 |
| 1 | CPC | 1.0 | 227 | 5,000 | 22 |
| 1 | CPC | 1.0 | 227 | 50,000 | 220 |
| 1 | Liq. Smk | 1.0 | 227 | 3,600 | 16 |
| | (Zesti) | | | | |
| 1 | Liq. Smk | 1.0 | 227 | 7,200 | 32 |
| 1 | Liq. Smk | 1.0 | 227 | 10,800 | 47 |
| 2 | CPC | 2.0 | 227 | 10,000 | 87 |
| 2 | CPC | 2.0 | 227 | 30,000 | 262 |
| 2 | Liq. Smk | 2.0 | 227 | 54,000 | 472 |
| 2 | Liq. Smk | 2.0 | 227 | 100,000 | 873 |
| | (Red | | | | |
| | Arrow) | | | | |
| 3 | CPC | 10.0 | 1816 | 10,000 | 55 |
| | (Turkey) | | | | |
| 3 | CPC | 10.0 | 1816 | 10,000 | 55 |
| 3 | CPC | 10.0 | 1816 | 10,000 | 55 |
| | (Pork) | | | | |
| 4 | Flavonoid | 2.0 | 227 | 3,000 | 26 |
| | Mist | | | | |
| 4 | Flavonoid | 0.4 gm | 227 | 200 | 0.4 |
| 5 | Flavonoid | 2.0 | 227 | 21,000 | 183 |
| | Mist | | | | |
| 5 | Flavonoid | 2.0 | 227 | 45,000 | 393 |
| | Mist | | | | |
| 5 | Flavonoid | 2.0 | 227 | 150,000 | 1,310 |
| | Mist | | | | |
| 6 | Flavonoid | 2.0 | 227 | 6,000 | 52 |
| | Mist | | | | |
| 6 | Flavonoid | 2.0 | 227 | 9,000 | 79 |
| | Mist | | | | |
| 6 | Flavonoid | 2.0 | 227 | 12,000 | 105 |
| | Mist | | | | |
| 6 | Flavonoid | 2.0 | 227 | 15,000 | 131 |
| | Mist | | | | |
| 6 | Flavonoid | 2.0 | 227 | 18,000 | 157 |
| | Mist | | | | |

| Test | | 0 | 6 | 13 | 20 | 27 | 34 | 41 | 48 |
|---|---|---|---|---|---|---|---|---|---|
| No. | Additive | Days | Days | Days | Days | Days | Days | Days | Days |
| 1 | CPC | 0.55 | 0.97 | 1.75 | 1.65 | 1.72 | 1.58 | 0.58 | |
| 1 | CPC | 3.08 | 3.48 | 2.98 | 3.73 | 3.72 | 1.70 | 0.58 | |
| 1 | CPC | 3.08 | 3.48 | 4.28 | 3.73 | 3.72 | 3.48 | 2.48 | |
| 1 | Liq. Smk | 0.36 | 0.52 | 1.24 | 0.83 | | | | |
| | (Zesti) | | | | | | | | |
| 1 | Liq. Smk | 0.40 | 1.88 | 1.35 | 0.95 | | | | |
| | (Zesti) | | | | | | | | |
| 1 | Liq. Smk | 0.48 | 0.30 | 1.31 | 0.88 | | | | |
| | (Zesti) | | | | | | | | |
| 2 | CPC | 3.08 | 5.32 | 5.04 | 5.36 | 5.52 | 5.87 | 6.28 | 6.62 |
| 2 | CPC | 3.08 | 5.32 | 5.04 | 5.36 | 5.52 | 5.87 | 6.28 | 6.62 |
| 2 | Liq. Smk | 1.00 | 2.54 | 2.26 | 4.06 | 2.44 | 2.61 | 3.50 | 3.84 |
| | (Zesti) | | | | | | | | |
| 2 | Liq. Smk | 1.08 | 3.32 | 3.74 | 3.58 | 1.92 | 1.87 | 0.61 | 1.58 |
| | (Red | | | | | | | | |
| | Arrow) | | | | | | | | |

| Test | | 0 | 7 | 14 | | | | |
|---|---|---|---|---|---|---|---|---|
| No. | Additive | Days | Days | Days | 21 Days | 28 Days | 35 Days | 42 Days |
| 3 | CPC | 2.81 | | 4.91 | | 5.90 | | 6.00 |
| | (Turkey) | | | | | | | |
| 3 | CPC | 2.99 | | 1.18 | | 2.48 | | 0.96 |
| | (Beef) | | | | | | | |
| 3 | CPC | 3.00 | | 1.30 | | 0.85 | | 1.30 |
| | (Pork) | | | | | | | |
| 4 | Flavonoid | 1.22 | 0.62 | 0.22 | 0.63 | 0.12 | 0.00 | 0.00 |
| | Mist | | | | | | | |
| 4 | Flavonoid | 1.52 | 1.21 | 2.70 | 0.99 | 3.60 | | |
| | Mist (Dry) | | | | | | | |
| 5 | Flavonoid | 3.85 | 3.45 | 4.43 | 6.00 | 6.77 | 7.60 | 7.52 |
| | Mist | | | | | | | |
| 5 | Flavonoid | 3.85 | 3.45 | 4.43 | 6.00 | 6.77 | 7.60 | 7.52 |
| | Mist | | | | | | | |
| 5 | Flavonoid | 3.85 | 3.45 | 4.43 | 6.00 | 6.77 | 7.60 | 7.52 |
| | Mist | | | | | | | |
| 6 | Flavonoid | 3.45 | 1.03 | 1.63 | 0.36 | 0.70 | | |
| | Mist | | | | | | | |
| 6 | Flavonoid | 3.45 | 1.81 | 1.58 | 0.26 | 0.89 | | |
| | Mist | | | | | | | |
| 6 | Flavonoid | 3.45 | 3.81 | 4.48 | 0.96 | 0.92 | | |
| | Mist | | | | | | | |
| 6 | Flavonoid | 3.45 | 3.81 | 4.48 | 0.90 | 1.04 | | |
| | Mist | | | | | | | |
| 6 | Flavonoid | 3.45 | 3.81 | 4.48 | 1.54 | 2.54 | | |
| | Mist | | | | | | | |

From these six tests, it was determined that when small volumes of antimicrobial compounds were added to vacuum packaged ready to eat food products, there was sufficient surface concentration of the active antimicrobial compounds to kill or inhibit the growth of contaminating bacteria. Examples from these six tests demonstrated that when concentrations of at least 0.5% CPC, at least 5% liquid smoke, and at least 0.02% Flavonoid Mist were applied to the surface of inoculated franks, as either a liquid, a mist, or a powder, the pathogen of study, Listeria monocytogenes, was sufficiently reduced and the shelf life of the product was extended by controlling other spoilage organisms over time after being packaged and sealed under a vacuum. At these levels of added antimicrobial compounds, the concentration based on total product weight was 22 ppm for CPC, 472 ppm for liquid smoke, and 0.4 ppm for Flavonoid Mist. Although the test data shows that a surface concentration of at least approximately 200 ppm and a product weight based concentration of at least approximately 2 ppm are effective, a surface concentration of at least approximately 100 ppm and a product weight based concentration of as low as approximately 0.4 ppm are also beneficial. The data also indicates that a product weight based concentration of approximately 100 ppm or less is beneficial. It can therefore be seen that the range of product weight based concentration from 0.4 ppm to 100 ppm and even greater is useful in inhibiting and/or preventing microbial growth. This of course varies with the weight of the product and the relative effectiveness of the antimicrobial agent used.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method of killing and inhibiting microbial growth of ready to eat meat and poultry products having an outer surface, comprising:
a. applying an antimicrobial agent to the outer surface of the ready to eat meat and poultry products, wherein the antimicrobial agent has a surface concentration of at least approximately 100 ppm and a product weight based concentration of approximately 100 ppm or less;
b. placing the ready to eat meat and poultry products in packaging; and
c. sealing the packaging under a vacuum, wherein the packaging contacts the ready to eat meat and poultry products and uniformly distributes the antimicrobial agent on the outer surface of the products.

2. The method of claim 1, wherein the packaging is a flexible film.

3. The method of claim 1, wherein the antimicrobial agent is effective in preventing microbial growth.

4. The method of claim 1, wherein the antimicrobial agent is a compound selected from the group consisting of quaternary ammonium compounds, liquid smoke, and herbal extracts.

5. The method of claim 1, wherein the antimicrobial agent has a surface concentration of at least approximately 200 ppm.

6. The method of claim 1, wherein the antimicrobial agent has a product weight based concentration of at least approximately 2 ppm.

7. A method of killing and inhibiting microbial growth of ready to eat meat and poultry products having an outer surface, comprising:
a. applying an antimicrobial agent to the outer surface of the ready to eat meat and poultry products, wherein the antimicrobial agent has a surface concentration of at least approximately 100 ppm;
b. placing the ready to eat meat and poultry products in packaging; and
c. sealing the packaging under a vacuum, wherein the packaging contacts the ready to eat meat and poultry products and uniformly distributes the antimicrobial agent on the outer surface of the products.

8. The method of claim 7, wherein the antimicrobial agent has a surface concentration of at least approximately 200 ppm.

9. A method of killing and inhibiting microbial growth of ready to eat meat and poultry products having an outer surface, comprising:
a. applying an antimicrobial agent to the outer surface of the ready to eat meat and poultry products, wherein the antimicrobial agent has a product weight based concentration of approximately 100 ppm or less;
b. placing the ready to eat meat and poultry products in packaging; and
c. sealing the packaging under a vacuum, wherein the packaging contacts the ready to eat meat and poultry products and uniformly distributes the antimicrobial agent on the outer surface of the products.

10. The method of claim 9, wherein the antimicrobial agent has a product weight based concentration of at least approximately 2 ppm.

11. A method of killing and inhibiting microbial growth of food products having an outer surface, comprising:
a. applying an antimicrobial agent to the outer surface of the food products;
b. placing the food products in packaging; and
c. sealing the packaging under a vacuum, wherein the packaging contacts the food products and uniformly distributes the antimicrobial agent on the outer surface of the food products.

12. The method of claim 11, wherein the antimicrobial agent is effective in preventing microbial growth.

13. The method of claim 11, wherein the antimicrobial agent has a surface concentration of at least approximately 100 ppm.

14. The method of claim 11, wherein the antimicrobial agent has a product weight based concentration of approximately 100 ppm or less.

15. The method of claim 11, wherein the antimicrobial agent is a compound selected from the group consisting of quaternary ammonium compounds, liquid smoke, and herbal extracts.

16. The method of claim 11, wherein the packaging is a flexible film.

17. A method of killing and inhibiting microbial contamination of ready to eat meat and poultry products having an outer surface, comprising:
a. applying an antimicrobial agent to the outer surface of the ready to eat meat and poultry products;
b. placing the ready to eat meat and poultry products in packaging; and
c. sealing the packaging under a vacuum, wherein the packaging contacts the ready to eat meat and poultry products and uniformly distributes the antimicrobial agent on the outer surface of the products, wherein the antimicrobial agent is effective in preventing microbial contamination.

18. The method of claim 17, wherein the antimicrobial agent has a surface concentration of at least approximately 100 ppm and a product weight based concentration of approximately 100 ppm or less.

19. The method of claim 17, wherein the antimicrobial agent has a surface concentration of at least approximately 200 ppm and a product weight based concentration of at least approximately 2 ppm.

20. A method of killing and inhibiting microbial contamination of ready to eat meat and poultry products having an outer surface, comprising:
a. applying cetylpyridinium chloride to the outer surface of the ready to eat meat and poultry products, wherein the cetylpyridinium chloride has a surface concentration of at least approximately 5,000 ppm and a product weight based concentration of at least approximately 22 ppm;
b. placing the ready to eat meat and poultry products in packaging; and
c. sealing the packaging under a vacuum, wherein the packaging contacts the ready to eat meat and poultry products and uniformly distributes the antimicrobial agent on the outer surface of the products.

21. The method of claim 20, wherein the cetylpyridinium chloride is effective in preventing microbial contamination.
